(19) United States
(12) Patent Application Publication
(10) Pub. No.: US 2008/0313079 A1
(43) Pub. Date: Dec. 18, 2008

(54) SYSTEM AND METHOD FOR PROXIMITY PAYMENT TRANSACTION BETWEEN A WIRELESS COMMUNICATION DEVICE AND A POINT OF SALE TERMINAL IN CONJUNCTION WITH A TRUSTED PARTY

(75) Inventors: JAMES A. VAN BOSCH, CRYSTAL LAKE, IL (US); MARK R. BRAUN, ARLINGTON HEIGHTS, IL (US); KENT D. RAGER, GURNEE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/763,207

(22) Filed: Jun. 14, 2007

(51) Int. Cl. G06Q 40/00

(52) U.S. Cl. 705/44; 235/379

(57) ABSTRACT

A method for proximity payment transaction between a wireless purchasing device and a point of sale terminal in conjunction with a trusted party. The wireless communication device initiates a proximity payment application for a transaction between the wireless purchasing device and the point of sale terminal. The wireless communication device transmits the first authentication code to the point of sale terminal. A first code is inputted at the point of sale terminal as a watermark on the superimposed photo image of the user, wherein the superimposed photo image is displayed on the wireless purchasing device. The point of sale terminal transmits a first code and the first authentication code to the trusted party via a second communication network. The point of sale terminal receives an approval message from the trusted party for approving the transaction between the wireless purchasing device and the point of sale terminal.

### FIELD OF THE DISCLOSURE

The present invention relates generally to the field of wireless payment method. More particularly, the present invention relates to a system and method for proximity payment transactions between a wireless communication device and a point of sale terminal in conjunction with a trusted party.

### BACKGROUND

Proximity payment is an area of interest to both the financial and mobile industries. A proximity payment application provides for the ability to make a transaction electronically using wireless communication devices. Having the ability to store and transfer currency electronically, the proximity payment application has brought the replacement of cash and coin transactions.

Proximity payment provides wireless transactions which are as fast as or faster than traditional methods of payment. The services for proximity payment offered by GSM and other mobile communication devices continue to evolve unabated.

Proximity payment enables a user of the wireless communication device to conduct wireless transaction using a proximity device. In some transactions, the identity of the user must be verified before a successful transaction is performed.

However, existing proximity payment application methods lack the ability to provide an adequate process for validating the user of the wireless communication device. Therefore, there is a need for a satisfactory method for validating the user of the wireless communication device.

### BRIEF DESCRIPTION OF FIGURES

FIG. 1 is a system diagram illustrating a communication system in which a wireless communication device may operate in accordance with embodiments of the present invention.

FIG. 2 is a block diagram illustrating exemplary components of a wireless communication device of FIG. 1.

FIG. 3 is a block diagram illustrating exemplary components of a trusted party of FIG. 1.

FIG. 4 is a block diagram illustrating exemplary components of a point of sale terminal of FIG. 1.

FIG. 5 is flow diagram illustrating an operation of one wireless communication device of FIG. 1 in accordance with embodiments of the present invention.

FIG. 6 is flow diagram illustrating an operation of one trusted party of FIG. 1 in accordance with embodiments of the present invention.

FIG. 7 is a flow diagram illustrating an operation of one wireless communication device, one point of sale terminal, and one trusted party in accordance with embodiments of the present invention.

### DETAILED DESCRIPTION

A system and method for proximity payment transactions between a wireless communication device and a point of sale terminal in conjunction with a trusted party includes verifying an identity of a user of the wireless communication device for approving or rejecting a transaction between the wireless communication device and the point of sale terminal.

One aspect of the present invention is a method for proximity payment transaction between a wireless purchasing device and a point of sale terminal in conjunction with a trusted party. A proximity payment application is initiated by the wireless communication device for a transaction between the wireless purchasing device and the point of sale terminal. A first authentication code of a superimposed photo image of a user of the wireless purchasing device is calculated by the wireless purchasing device. The first authentication code is transmitted by the wireless purchasing device to the point of sale terminal via a first communication network. A first code placed as a watermark on the superimposed photo image of the user is inputted at the point of sale terminal, wherein the superimposed photo image is displayed on the wireless purchasing device. The first code and the first authentication code are transmitted to the trusted party by the point of sale terminal via a second communication network. An approval message is received by the point of sale terminal from the trusted party for approving the transaction between the wireless purchasing device and point of sale terminal via the second communication network.

Another aspect of the present invention is a system for performing proximity payment transaction process comprising a wireless purchasing device, a point of sale terminal, and a trusted party. The wireless purchasing device is configured to calculate a first authentication code over a superimposed photo image of a user of the wireless purchasing device, wherein the superimposed photo image is stored in a first memory of the wireless purchasing device. The point of sale terminal is connectable to the wireless purchasing device via a first communication network. The point of sale terminal is configured for inputting a first code placed as a watermark on the superimposed photo image, wherein the superimposed photo image is displayed on the wireless purchasing device. The trusted party is connectable to the point of sale terminal via a second communication network. The trusted party is configured for approving a transaction between the wireless purchasing device and the point of sale terminal.

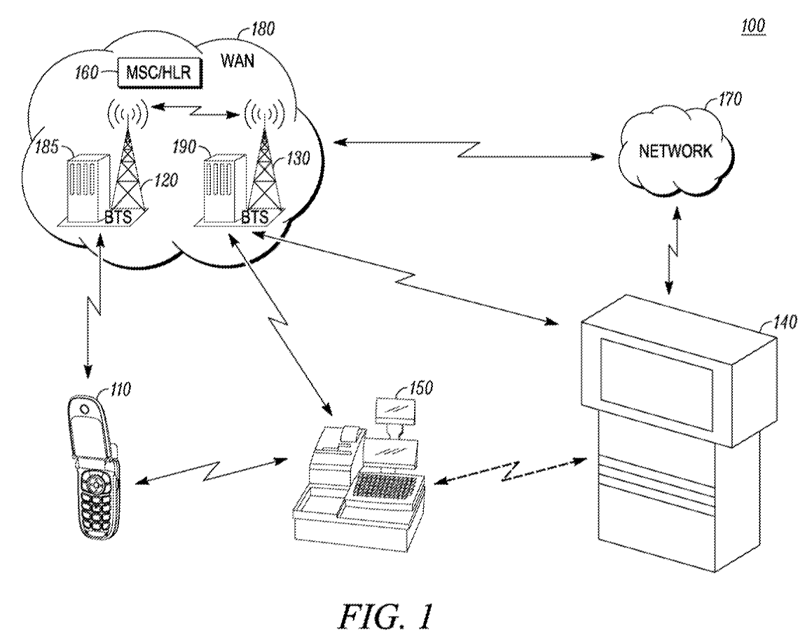

Turning now to the drawings where like numerals represent like components, FIG. 1 is a system diagram illustrating a communication system 100 including a wireless communication device 110, wireless towers 120, 130, a point of sale terminal 150, and a trusted party 140 for performing a proximity payment application. A proximity payment is a wireless payment technology that enables faster payment transactions without a use of plastic payment cards (e.g., credit/debit cards) and cash.

The proximity payment application is a wireless payment application which enables the wireless communication device 110 to secure payment credential data and conduct wireless payment transactions. The proximity payment application enables functions on the wireless communication device 110 for communications with the trusted party 140, and the point of sale terminal 150 to perform proximity payment provisioning and a proximity payment transaction process. In one example, the proximity payment application is software loaded or installed on the wireless communication device 110, the trusted party 140, and the point of sale terminal 150. Proximity payment provisioning enables the wireless communication device 110 to secure data and maintain the secured data to perform a transaction by using the proximity payment transaction process. The proximity payment transaction process enables the wireless communication device 110 to perform a wireless payment transaction using the secured data stored during proximity payment provisioning. The proximity payment transaction is assisted by simultaneous functioning of the wireless communication device 110, the point of sale terminal 150, and the trusted party 140 to perform the transaction. As used herein, a transaction is defined as an exchange of data that can be used for purchasing a product or a service.

The wireless communication device 110 initiates the proximity payment application. The wireless communication device 110 communicates with the wireless towers 120, 130, the point of sale terminal 150, and the trusted party 140 via long-range communication and/or short-range wireless communication. In one example, the wireless communication device 110 exchanges payment credential data with the point of sale terminal 150 to successfully conduct the wireless payment transaction. In one example, the long range communication is also known as a second communication network. In another example, the short-range wireless communication is also known as a first communication network.

The wireless communication device 110 communicates with the cellular network 180 using wireless communication protocols such as Advanced Mobile Phone System (AMPS), Code Division Multiple Access (CDMA), Time Division Multiple Access (TDMA), Global System For Mobile Communications (GSM), Integrated Digital Enhanced Network (iDEN), General Packet Radio Service (GPRS), Enhanced Data for GSM Evolution (EDGE), Universal Mobile Telecommunications System (UMTS), Wideband Code Division Multiple Access (WCDMA), and their variants. The wireless communication device 110 may communicate using an ad-hoc network or wireless local area network such as 802.11 and the like. The wireless communication device 110 may also communicate using short-range wireless communication like Bluetooth, Near Field Communication (NFC), Radio Frequency Identification (RFID), infrared, and the like.

The cellular network 180 is a wide area network (WAN) and comprises various components such as Base Transceiver Stations (BTS) 185, 190 and Mobile Switching Center (MSC) 160 which also comprises a Home Location Register (HLR). It is to be understood that the WAN 180 as shown in FIG. 1 is for illustrative purposes only, and that the WAN will comprise a number of BTSs, MSCs, HLRs, as well as other components not mentioned herein. The WAN 180 may also communicate with other networks such as network 170, which may be the Internet, which may make use of any suitable means including, but not limited to; a leased telephone line, T1, E1, infra-red, or a radio frequency point-to-point connection.

In one embodiment of the present invention, the wireless communication device 110 may be known as a wireless purchasing device, since it is used to carry out the transaction between the wireless communication device 110 and the point of sale terminal 150. In another embodiment of the present invention, the wireless communication device 110 may also be known as a client device, a subscriber, a mobile station, and the like. The wireless communication device 110 may be any suitable wireless communication device, including a cell phone, a personal digital assistant (PDA), a hand-held computer, a Bluetooth headset, and the like. Further, it should be understood that the present invention is not limited to a wireless communication device. Other types of wireless access terminals which include fixed wireless terminals may be used. For a better understanding, only the term wireless communication device is used herein and discussed hereafter. However, it should be understood that the term “wireless communication device” in the claims and description below includes both truly wireless communication devices (e.g., mobile phones, wireless handheld computers), stationary wireless terminals (e.g., fixed wireless router) or any other electronic battery operated devices coupled to a network.

In one embodiment of the present invention, the wireless communication device 110 is utilized by multiple users. For example, different members of the same family may use the wireless communication device 110. In this case, the wireless communication device 110 holds multiple profiles for the different members of the family. By having multiple profiles, multiple users may use the same wireless communication device 110 to perform multiple transactions.

Wireless towers 120, 130 establish a communication link among the wireless communication device 110, the trusted party 140, and the point of sale terminal 150. Wireless towers 120, 130 also transfer voice and data signals between each other via the communications link. The communication link is a wired communication link, a wireless communication link, and/or a combination of both. In one example, the wireless communication link is a high-speed data communication link. In one embodiment of the present invention, the wireless towers 120, 130 are base stations which transfer data through GPRS or the Internet to the wireless communication device 110.

Trusted party 140 performs a verification process to verify the identity of the user of the wireless communication device 110. In addition to the verification process, the trusted party 140 is also capable of providing services requested by the user of the wireless communication device 110. In one example, the trusted party 140 is capable of storing user information in a database. The trusted party 140 is connectable to the wireless communication device 110 and the point of sale terminal 150 via long-range communication through wireless towers 120, 130. The long-range communication is a wired and/or a wireless long-range communication. The long-range communication may adhere to wireless communication protocols as mentioned earlier. In another example, the trusted party 140 is a network server of a financial institution which performs the verification process, provides services to the user, and maintains the database of the user information.

Point of sale terminal 150 is configured to carry out the transaction with the wireless communication device 110 by facilitating the proximity payment transaction process. In one example, the point of sale terminal 150 is connectable to the wireless communication device 110. In connection with the wireless communication device 110, the point of sale terminal 150 may utilize short-range wireless communication, as mentioned above. In connection with the trusted party 140, the point of sale terminal 150 utilizes long-range communication. As mentioned above, the long-range communication may be a wired and/or a wireless long-range communication.

In one example, an operator operates the point of sale terminal 150 for facilitating the transaction with the wireless communication device 110. For example, the operator inputs data into the point of sale terminal 150 using an input interface on the point of sale terminal 150. The point of sale terminal 150 may be coupled or integrated into an electronic cash register. In one example, the point of sale terminal 150 is another wireless communication device, where another wireless communication device functions as the point of sale terminal 150. In this case, proximity payment provisioning and the proximity payment transaction process are then performed between two wireless communication devices 110, 150. Additionally, a connection to the trusted party 140 may be required for performing proximity payment provisioning and the proximity payment transaction process between the two wireless communication devices 110, 150. In another example, the point of sale terminal 150 includes a NFC reader and is known as a NFC point of sale terminal.

In one embodiment of the present invention, the point of sale terminal 150 and the trusted party 140 may be connected directly via a separate wired connection, e.g. T1 or phone line.

Operationally in the illustrated embodiment of the communication system 100, the wireless communication device 110 initiates the proximity payment application to perform proximity payment provisioning. In one example, the wireless communication device 110 initiates the proximity payment application using a user interface built-in the wireless communication device 110. After initiating, the wireless communication device 110 loads a photo image of the user of the wireless communication device 110. The loaded photo image is then transmitted to the trusted party 140 via long-range communication. The trusted party 140 after receiving the photo image superimposes the photo image with a watermark. The trusted party 140 then calculates an authentication code over the superimposed photo image and stores the calculated authentication code in a memory. Further, the trusted party 140 transmits the superimposed photo image to the wireless communication device 110. The superimposed photo image received by the wireless communication device 110 is then stored in a memory of the wireless communication device 110.

Operationally in the illustrated embodiment of the communication system 100, the wireless communication device 110 initiates the proximity payment application to perform the proximity payment transaction. The proximity payment transaction process enables the wireless communication device 110 to perform the transaction with the point of sale terminal 150. In one example, the wireless communication device 110 initiates the proximity payment application using the user interface built-in the wireless communication device 110. After initiating, the wireless communication device 110 calculates the authentication code of the superimposed photo image. The calculated authentication code is then transmitted to the point of sale terminal 150 via short-range wireless communication. The point of sale terminal 150 receives the authentication code from the wireless communication device 110. In one example, the operator operating the point of sale terminal 150 inputs a code placed as the watermark on the superimposed photo image. This step is done to ensure that the operator operating the point of sale terminal is forced to look at the photo image with the watermark to verify the user's identity. Further, the point of sale terminal 150 transmits the code and the authentication code to the trusted party 140 via long-range communication. After receiving, the trusted party 140 verifies the identity of the user based upon the received code and the received authentication code. The trusted party 140 then transmits an approval message to the point of sale terminal 150 for approving the transaction. Alternatively, the trusted party 140 transmits a rejection message to the point of sale terminal 150 for rejecting the transaction.

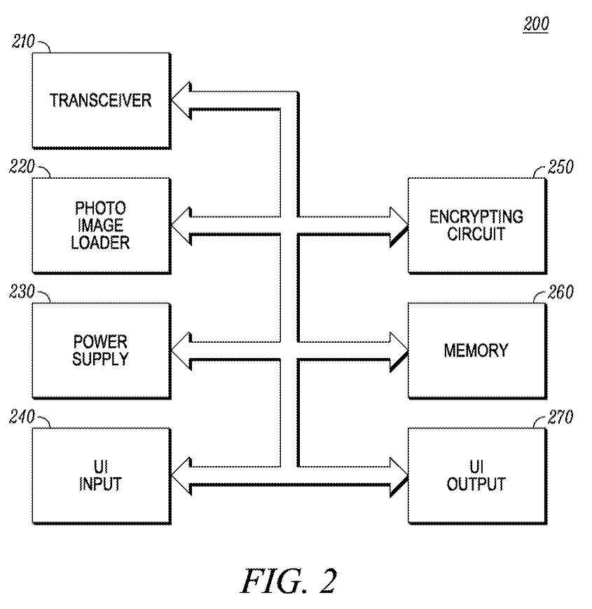

Referring to FIG. 2, there is provided a block diagram illustrating exemplary internal components 200 of the wireless communication device 110. The wireless communication device 110 includes a transceiver 210, a photo image loader 220, a power supply 230, an encrypting circuit 250, a memory 260, one or more input devices 240, and one or more output devices 270. The power supply 230 supplies power to rest of the internal components 200. The power supply 230 is an alternating current (AC) supply or a direct current (DC or “continuous current”) supply.

The transceiver 210 transmits the photo image of the user of the wireless communication device 110 to the trusted party 140 via long-range communication during proximity payment provisioning. In one example, the transceiver 210 is also configured to send personalized data of the user to the trusted party 140 along with the photo image. For example, the personalized data contains a signature of the user, a name of the user, a date of birth of the user or any other personal data. In another example, the transceiver 210 is configured to transmit a unique identifier along with the photo image to the trusted party 140. The unique identifier is a unique identifier value of a hardware component of the wireless communication device 110.

In one embodiment of the present invention, the transceiver 210 receives the superimposed photo image from the trusted party 140. The received superimposed photo image includes the watermark. In one example, the watermark superimposed on the received photo image is known as a first code.

The transceiver 210 may be a wired transceiver, such as a transceiver with an Ethernet connection, or a wireless transceiver such as an RF transceiver. In one example, the transceiver 210 communicates wirelessly using the wireless communication protocols mentioned earlier. As is known, the transceiver 210 is a combination of a transmitter and a receiver. Therefore, the transmitter and the receiver may be used separately instead of the transceiver 210. In one embodiment of the present invention, two separate transceivers may be used. In this case, a first transceiver may be used for long-range communication and a second transceiver may be used for short-range wireless communication.

In another example, the transceiver 210 may be configured to transmit the authentication code to the point of sale terminal 150. The point of sale terminal 150 can use the transmitted authentication code to perform the transaction during the proximity payment transaction process. Additionally, the transceiver 210 is also configured to transmit the superimposed photo image to the point of sale terminal 150.

The memory 260 is configured to store the superimposed photo image of the user of the wireless communication device 110. In one embodiment of the present invention, the memory 260 also stores the authentication code. In one example, the memory 260 is an integrated memory of the wireless communication device 110 or a removable memory, such as an external memory card or SIM card. In one embodiment of the present invention, the memory 260 of the wireless communication device 110 is known as a first memory. In one example, the memory 260 may also be known as a secure memory. In this case, the secure memory may store the superimposed photo image only after successful completion of proximity payment provisioning, which involves usage of cryptographic methods.

The photo image loader 220 may be configured to load the photo image of the user. After loading the photo image, the photo image loader 220 stores the loaded photo image in the memory 260. The storing of the photo image in the memory 260 is performed during proximity payment provisioning. In one example, the photo image loader 220 may store the photo image in the memory 260 and use the stored photo image for proximity payment provisioning at a later time. In another example, the photo image loader 220 is an integrated camera of the wireless communication device 110. The integrated camera is used to capture the photo image of the user of the wireless communication device 110. Alternatively, the photo image loader 220 is an external camera attached to the wireless communication device 110 to capture the photo image of the user. In one example, the photo image loader 220 loads the photo image of the user via wired connection and/or wireless connection. In case of wireless connection, the photo image loader 220 utilizes Bluetooth, infrared, and their variants. In case of wired connection, the photo image loader 220 utilizes a USB port and its variants. In another example, the photo image loader 220 downloads the photo image using a GPRS or an internet connection and stores the photo image in the memory 260. In another example, the photo image may be captured by an external camera, and saved to a removable memory device. The removable memory device may then be inserted into the wireless communication device 110. The photo image loader 220 may then load the photo image from the removable memory device.

The encrypting circuit 250 may be configured to calculate the authentication code. In one example, the encrypting circuit 250 calculates the authentication code for use in proximity payment provisioning and the proximity payment transaction process. The authentication code may be calculated over the superimposed photo image. Optionally, the calculated authentication code may be stored in the memory 260. In one example, the authentication code is a cryptographic hash digest code, a hash message authentication code, an encrypted value using DES or Triple DES, or a digital signature. In another example, the cryptographic hash digest code is a hash function used for certain security properties. The security properties are suitable for use in various information security applications, such as authentication and message integrity. In one example, hash algorithms such as SHA-1 or SHA-256 are used for calculating the authentication code. As is known, any kind of hash algorithm may be used to calculate the authentication code. In one embodiment of the present invention, the authentication code calculated by the wireless communication device 110 is known as a first authentication code.

The input and output devices 240, 270 provide interface for the user of the wireless communication device 110 to facilitate the proximity payment application. The input and output devices 240, 270 of the internal components 200 include a variety of video, audio and/or mechanical outputs. For example, the output device(s) 270 includes a video output device such as a liquid crystal display and light emitting diode indicator, an audio output device such as a speaker, alarm and/or buzzer, and/or a mechanical output device such as a vibrating mechanism. Likewise, by example, the input device(s) 240 includes a video input device such as an optical sensor (for example, a camera), an audio input device such as a microphone, and a mechanical input device such as a flip sensor, a keyboard, a keypad, a selection button, a touch pad, a touch screen, a capacitive sensor, a motion sensor, and a switch. Actions that actuate one or more input devices 240 include, but are not limited to, opening the wireless communication device, unlocking the device, moving the device to actuate a motion, moving the device to actuate a location positioning system, and operating the device.

Operationally during proximity payment provisioning, the wireless communication device 110 initiates the proximity payment application to perform proximity payment provisioning between the wireless communication device 110 and the trusted party 140. The photo image loader 220 loads the photo image of the user. The transceiver 210 transmits the photo image to the trusted party 140 via long-range communication. In addition to transmitting, the transceiver 210 also receives the superimposed photo image from the trusted party 140 via long-range communication. The received superimposed photo image is stored in the memory 260.

Operationally during the proximity payment transaction process, the wireless communication device 110 initiates the proximity payment application to perform the transaction with the point of sale terminal 150. After initiating, the wireless communication device 110 calculates the first authentication code of the superimposed photo image. The calculated first authentication code is then transmitted to the point of sale terminal 150 using the transceiver 210 via short-range wireless communication. In one example, the superimposed photo image is also transmitted to the point of sale terminal 150 along with the first authentication code.

It is to be understood that FIG. 2 is for illustrative purposes only and is for illustrating internal components 200 of the wireless communication device 110, in accordance with the present invention, and is not intended to be a complete schematic diagram of the various components required for the wireless communication device 110. Therefore, the wireless communication device 110 includes various other components not shown in FIG. 2 and is still within the scope of the present invention.

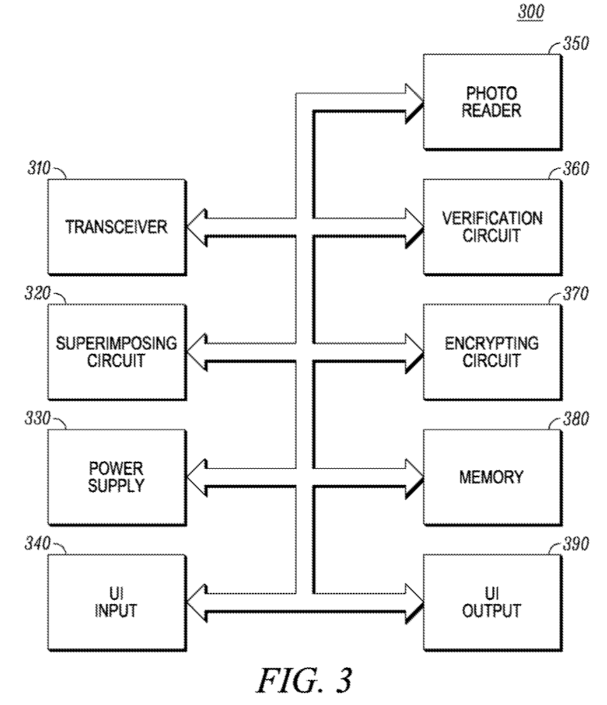

Referring to FIG. 3, there is provided a block diagram illustrating exemplary internal components 300 of the trusted party 140. As mentioned before, the trusted party 140 is the network server of the financial institution. The trusted party 140 includes a transceiver 310, a superimposing circuit 320, a power supply 330, a photo reader 350, a verification circuit 360, an encrypting circuit 370, a memory 380, one or more input devices 340, and one or more output devices 390. The power supply 330 supplies power to rest of the internal components 300. The power supply 330 is an alternating current (AC) supply or a direct current (DC or “continuous current”) supply.

The transceiver 310 is configured to receive the photo image of the user from the wireless communication device 110. In one example, the transceiver 310 is also configured to receive personal data of the user along with the photo image. In one embodiment of the present invention, the transceiver 310 receives the first authentication code and the first code from the point of sale terminal 150 during the proximity payment transaction process. In another example, the transceiver 310 is also configured to transmit the superimposed photo image of the user to the wireless communication device 110. Additionally, the transceiver 310 may be configured to receive the device identifier of the wireless communication device 110 along with the photo image. The transceiver 310 is a wired transceiver, such as a transceiver with an Ethernet connection, or a wireless transceiver such as an RF transceiver. In one example, the transceiver 310 communicates wirelessly using the wireless communication protocols mentioned earlier. As mentioned earlier, in one example two separate transceivers may be used for long-range communication and short-range wireless communication. For example, one transceiver for long-range communication and another transceiver for short-range wireless communication.

The superimposing circuit 320 is configured to superimpose the watermark on the photo image of the user of the wireless communication device 110. In one example, the watermark superimposed on the photo image of the user is an approval code, a user identifier of the user, a device identifier of a hardware component of the wireless communication device 110, a serial number of the wireless communication device 110, and other personalized data. In another example, the watermark is a decimal number, a security code typically found on the back of a credit card, or an image of a handwritten signature of the user of the wireless communication device 110. In this example, the handwritten signature is sent as personalized data along with the photo image by the user to the trusted party 140. The hand written signature may be captured on a smart phone, such as a PDA, using handwriting recognition hardware and software. In another example, a picture is captured of a signature of the user using the camera built-in or externally attached to the wireless communication device 110. In one example, the signature may be sent to the trusted party 140 via electronic mail, or the trusted party 140 may already have the user's signature in their records and may scan and superimpose the user's signature on the photo image as a second watermark.

In one example, the superimposing circuit 320 is configured to pre-pend or post-pend the device identifier onto the superimposed photo image before the authentication code is calculated by the encrypting circuit 370.

The photo reader 350 is configured to verify whether the photo image of the user received from the wireless communication device 110 is a legible photo image or not. As used herein and referred hereafter, a legible photo image is a photo image which is clear and precise. The photo reader verifies the photo image before the superimposing circuit 320 superimposes the watermark on the photo image. In one example, the photo reader 350 makes sure that the received photo image of the user meets the quality requirements of the trusted party 140 for superimposing the watermark.

The encrypting circuit 370 is configured to calculate the authentication code of the superimposed photo image. The encrypting circuit 370 calculates the authentication code during proximity payment provisioning or during the proximity payment transaction process. The authentication code calculated by the encrypting circuit 370 is stored in the memory 380 and is known as a second authentication code. The second authentication code is used for user verification purpose during the proximity payment transaction process. In one example, the encrypting circuit 370 is also configured to calculate the authentication code over the superimposed photo image, pre-pended or post-pended with the device identifier. As described before, the authentication code is a cryptographic hash digest code, a hash message authentication code, an encrypted value using DES or Triple DES, or a digital signature.

In one example, the encrypting circuit 370 comprises different types of hash algorithms which may be used for calculating the authentication code. In this case, the wireless communication device 110 specifies to the trusted party 140, the type of hash algorithm the wireless communication device 110 is using so that the same type of hash algorithm is used by the encrypting circuit 370 to calculate the authentication code.

The memory 380 is configured to store the authentication code calculated by the encrypting circuit 370. The memory 380 may also be configured to store the superimposed photo image of the user of the wireless communication device 110. In one example, the memory 380 is known as a second memory. In one embodiment of the present invention, the watermark superimposed on the photo image of the user is stored in the memory 380. In this example, the stored watermark is known as a second code.

The verification circuit 360 is configured to verify whether the first authentication code is same as the second authentication code and the first code is same as the second code. In one example, the verification circuit 360 verifies whether the first code entered by the operator operating the point of sale terminal 150 is a correct code as superimposed on the photo image of the user which is displayed on the wireless communication device 110.

The input and output devices 340, 390 provide an interface for the trusted party 140 to facilitate proximity payment provisioning and the proximity payment transaction process. The input and output devices 340, 390 of the internal components 300 include a variety of video, audio and/or mechanical outputs. For example, the output device(s) 390 includes a video output device such as a liquid crystal display and light emitting diode indicator, an audio output device such as a speaker, alarm and/or buzzer, and/or a mechanical output device. Likewise, by example, the input device(s) 340 includes a video input device such as an optical sensor (for example, a camera), an audio input device such as a microphone, and a mechanical input device such as a keyboard, a keypad, a selection button, a touch pad, a touch screen, a capacitive sensor, a motion sensor, and a switch.

It is to be understood that FIG. 3 is for illustrative purposes only and is for illustrating internal components 300 of the trusted party 140, in accordance with the present invention, and is not intended to be a complete schematic diagram of the various components required for the trusted party 140. Therefore the trusted party 140 includes various other components not shown in FIG. 3 and is still within the scope of the present invention.

Operationally during proximity payment provisioning, the trusted party 140 receives the photo image of the user of the wireless communication device 110 using the transceiver 310 via long-range communication. The photo reader 350 verifies whether the received photo image is a legible photo image or not before the superimposing circuit 320 superimposes the watermark. If the received photo image is a legible photo image, the superimposing circuit 320 superimposes the received photo image with the watermark and stores the watermark as the second code in the memory 380. The transceiver 310 then transmits the superimposed photo image to the wireless communication device 110 via long-range communication. In one example, the trusted party 140 also stores the superimposed photo image in the memory 380. The encrypting circuit 370 calculates the authentication code of the superimposed photo image and stores the calculated authentication code in the memory 380.

Operationally during the proximity payment transaction process, the trusted party 140 receives the first authentication code and the first code from the point of sale terminal 150. The verification circuit 360 compares the first authentication code and the first code received from the point of sale terminal 150 to the second authentication code and the second code. After verifying, the trusted party 140 transmits the approval message to the point of sale terminal 150 for approving the transaction between the wireless communication device 110 and the point of sale terminal 150. Alternatively, the trusted party 140 sends the rejection message for rejecting the transaction.

In one embodiment of the present invention, the trusted party 140 provides services to multiple wireless communication devices at one time. In one example, the memory 380 holds multiple accounts for multiple wireless communication devices. In this example the trusted party 140 stores multiple authentication codes for multiple users using the multiple wireless communication devices.

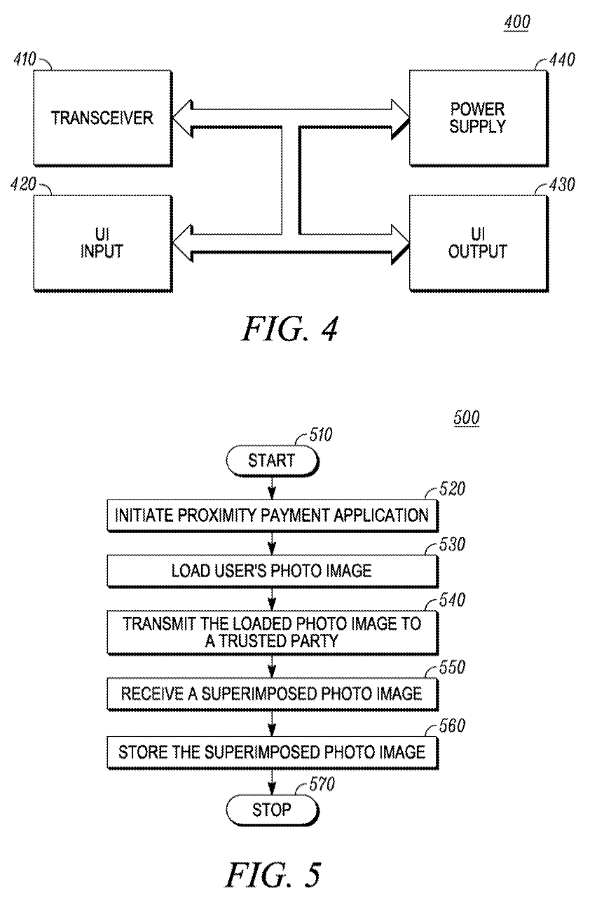

Referring to FIG. 4, there is provided a block diagram illustrating exemplary internal components 400 of the point of sale terminal 150. The point of sale terminal 150 includes one or more transceiver 410, a power supply 440, one or more input devices 420 and one or more output devices 430. The power supply 440 supplies power to rest of the internal components 400. The power supply 440 is an alternating current (AC) supply or a direct current (DC or “continuous current”) supply.

The transceiver 410 is configured to receive the first authentication code from the wireless communication device 110 via short-range wireless communication during the proximity payment transaction process The transceiver 410 is also configured to transmit the first code and the first authentication code to the trusted party 140 via long-range communication during the proximity payment transaction process. In one example, the transceiver 410 is configured to receive the superimposed photo image from the wireless communication device 110 via short-range wireless communication. In another example, the transceiver 410 is also configured to receive the approval message from the trusted party 140 for approving the transaction via long-range communication. Additionally, the transceiver 410 is configured to receive the rejection message from the trusted party 140. As mentioned earlier, in one example two separate transceivers may be used for long-range communication and short-range wireless communication.

The input and output devices 420, 430 allow the point of sale terminal 150 to perform the proximity payment transaction process. The input and output devices 420, 430 of the internal components 400 include a variety of video, audio and/or mechanical outputs. For example, the output device(s) 430 includes a video output device such as a liquid crystal display and light emitting diode indicator, an audio output device such as a speaker, alarm and/or buzzer, and/or a mechanical output device such as a vibrating mechanism. Likewise, by example, the input device(s) 420 includes a video input device such as an optical sensor (for example, a camera), an audio input device such as a microphone, and a mechanical input device such as a keyboard, a keypad, a selection button, a touch pad, a touch screen, and a switch.

It is to be understood that FIG. 4 is for illustrative purposes only and is for illustrating internal components 400 of the point of sale terminal 150, in accordance with the present invention, and is not intended to be a complete schematic diagram of the various components required for the point of sale terminal 150. Therefore the point of sale terminal 150 includes various other components not shown in FIG. 4 and is still within the scope of the present invention.

Operationally, the point of sale terminal 150 receives the first authentication code from the wireless communication device 110 via short-range wireless communication. In one embodiment of the present invention, the operator operating the point of sale terminal 150 inputs the first code placed as the watermark on the superimposed photo image, where the superimposed photo image is displayed on the wireless communication device 110. As an example, the operator operating the point of sale terminal 150 inputs the first code into the point of sale terminal 150 using the user interface, such as the input device 420. Optionally, the point of sale terminal receives the superimposed photo image from the wireless communication device 110. In this case, the operator then looks at the superimposed photo image on a display of the point of sale terminal 150 and inputs the first code. In any case, the point of sale terminal 150 transmits the first code and the first authentication code to the trusted party 140 via long-range communication. The point of sale terminal 150 receives the approval message from the trusted party 140 for approving the transaction via long-range communication. Alternatively, the point of sale terminal 150 receives a rejection message from the trusted party 140 for rejecting the transaction.

Referring to FIG. 5, shown is a flow diagram 500 of an operation of a wireless communication device, e.g. wireless communication device 110, during proximity payment provisioning. The proximity payment application is initiated (step 520) to perform proximity payment provisioning. After initiating, the photo image of the user of the wireless communication device is loaded (step 530), e.g. by the photo image loader 220. The loaded photo image is then transmitted to a trusted party e.g. the trusted party 140 (step 540) via long-range communication

In one example, the trusted party 140 may verify an identity of the user of the wireless communication device 110 based upon a user name, a password, and the like, before proceeding to step 530.

Alternate methods for sending the photo image of the user to the trusted party 140 may include, sending the photo image via mail, such as via postal mail or electronic mail. In another example, the user delivers in person the photo image to the trusted party. Alternatively, the user loads the photo image on a personal computer (including Laptop) using a digital camera (such as a webcam), where the digital camera is connected to the personal computer via wireless connection (e.g., Bluetooth, infrared) and/or via wired connection (e.g., USB cable). The loaded photo image on the personal computer is then transmitted via electronic mail.

In one example, the device identifier is also transmitted along with the photo image. The device identifier is a unique identifier of a hardware component of the wireless communication device, e.g. a unique identifier value that is permanently stored in a processor by a semiconductor manufacturer, a serial number of the wireless communication device, a serial number of a battery used in the wireless communication device, and the like.

A superimposed photo image is received (step 550) via long-range communication. The received superimposed photo image is stored in a memory (step 560), e.g. the memory 260. The stored superimposed photo image is then recovered during the proximity payment transaction process to allow the user to perform the transaction successfully.

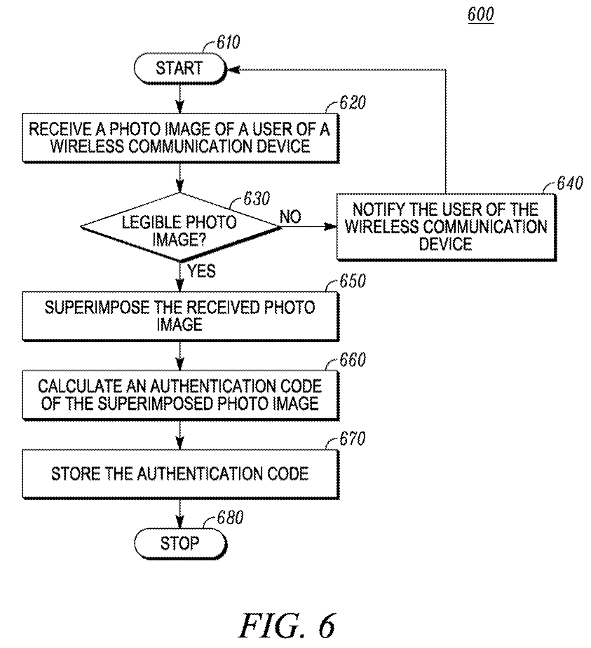

Referring now to FIG. 6, shown is a flow diagram 600 of an operation of a trusted party, e.g. trusted party 140, during proximity payment provisioning. The photo image of the user is received (step 620) via long-range communication. Alternatively, the photo image may be received through alternate methods as described earlier. In any case, after the step of receiving, the photo image is verified for a legible photo image (step 630), e.g. by the photo reader 350. If the photo image is not a legible photo image, the user is notified (step 640) by transmitting a notification message. In this example, the notification message requests the user to transmit a new photo image. Thus, steps 610 to 630 are repeated until a legible photo image is received.

Alternatively, if the photo image is a legible photo image, a watermark is superimposed on the photo image (step 650), e.g. by the superimposing circuit 320. Further, an authentication code of the superimposed photo image is calculated (step 660), e.g. by the encrypting circuit 370. Thereafter, the authentication code is stored in a memory (step 670), e.g. the memory 380.

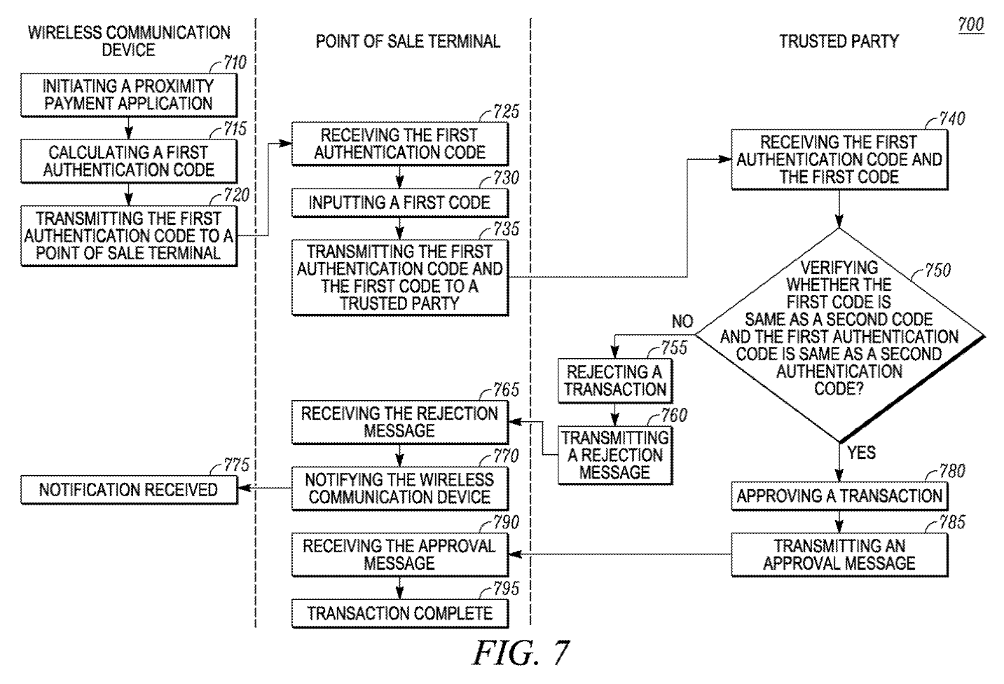

Referring now to FIG. 7, shown is a flow diagram 700 of an operation to perform the proximity payment transaction process. As mentioned earlier, the proximity payment transaction process is assisted by simultaneous functioning of a wireless communication device, e.g. wireless communication device 110, a point of sale terminal, e.g. point of sale terminal 150, and a trusted party, e.g. trusted party 140. The proximity payment application is initiated (step 710) to perform the proximity payment transaction process. The proximity payment transaction process enables the wireless communication device to perform a transaction with the point of sale terminal.

After initiating the proximity payment application, the first authentication code is calculated (step 715) over the superimposed photo image. For example, the encrypting circuit 250 calculates the first authentication code. Alternatively, the first authentication code is calculated during proximity payment provisioning. In this case, the first authentication code is then stored in the memory, e.g. the memory 260, along with the superimposed photo image.

The first authentication code is then transmitted to the point of sale terminal (step 720) via short-range wireless communication. After receiving the first authentication code (step 725), the first code placed as the watermark on the superimposed photo image is inputted in the point of sale terminal (step 730). In this case, the superimposed photo image is displayed on the wireless communication device. As mentioned earlier, the operator operating the point of sale terminal inputs the first code into point of sale terminal using the user interface, such as an input device, e.g. the input device 420.

Alternatively, the wireless communication device transmits the superimposed photo image to the point of sale terminal along with the first authentication code. In this case, the superimposed photo image is displayed on the point of sale terminal, such as on an output interface, e.g. the output device 430. The operator then looks at the displayed superimposed photo image on the point of sale terminal and inputs the first code. In any case, the point of sale terminal transmits the first code and the first authentication code to the trusted party (step 735).

After receiving the first authentication code and the first code (step 740), verification is done to verify whether the first code is same as the second code and whether the first authentication code is same as the second authentication code (step 750). As mentioned before, the second code and the second authentication code are stored in a memory of the trusted party, e.g. the memory 380, during proximity payment provisioning.

Alternatively, the superimposed photo image is stored in the memory of the trusted party during proximity payment provisioning. In this case, the second authentication code is calculated over the stored superimposed photo image during the proximity payment transaction process.

If it is determined that the first code is not same as the second code and the first authentication code is not same as the second authentication code (step 750), the transaction between the wireless communication device and the point of sale terminal is rejected (step 755). After the transaction is rejected, a rejection message is transmitted to the point of sale terminal (step 760). The point of sale terminal after receiving the rejection message (step 765), may notify the user of the wireless communication device (step 770) about the rejection of the transaction. Further, the point of sale terminal transmits a notification to the user, which is received by the user on the wireless communication device (step 775). In this example, the notification to the user may request the user to perform the transaction again.

In one example, the rejection message may be displayed on the wireless communication device and/or the point of sale terminal. The rejection message may be a text message, e.g. “transaction rejected—Please try again”. The rejection message may also be an alarm sound on an audio output of the wireless communication device and/or the point of sale terminal.

Alternatively, if it is determined that the first code is same as the second code and the first authentication code is same as the second authentication code (step 750), the transaction between the wireless communication device and the point of sale terminal is approved (step 780). After the transaction is approved, an approval message is transmitted to the point of sale terminal (step 785). The point of sale terminal after receiving the approval message (step 790), completes the transaction (step 795).

In one embodiment of the present invention, the point of sale terminal, e.g. point of sale terminal 150, receives the first code and the first authentication code from the wireless communication device, e.g. wireless communication device 110. Additionally, the point of sale terminal also receives the second code and the second authentication code from trusted party, e.g. trusted party 140. After receiving, the point of sale terminal compares the first code to the second code and the first authentication code to the second authentication code for approving the transaction. For example, the first code, the second code, the first authentication code, and the second authentication code are displayed on the point of sale terminal and the operator compares them visually. The operator then rejects or approves the transaction based upon visual comparison.

In one example, the wireless communication device may transmit the superimposed photo image to the point of sale terminal via a short-range wireless communication. The point of sale terminal after receiving the superimposed photo image may then calculate an authentication code. Additionally, the operator operating the point of sale terminal may input a code displayed as a watermark on the superimposed photo image. In this case, the superimposed photo image may be displayed on the point of sale terminal or the wireless communication device. The point of sale terminal may then transmit the calculated authentication code and the code to the trusted party for verification purpose.

In one example, the transaction between the wireless communication device and the point of sale terminal depends upon an amount of the transaction. For example, after the wireless communication device initiates the proximity payment application, e.g. step 710, the point of sale terminal may check the amount of the transaction. If the amount of the transaction is low, the point of sale terminal may not request for additional information to verify an identity of the user. For example, if the amount of the transaction is low (e.g. while performing a transaction at a gas station), the transaction may be performed by the point of sale terminal without the requirement of any credential information.

Alternatively, if the amount of the transaction is high, steps 715 to 795 are repeated in the same order as described for FIG. 7. In this case, the point sale terminal requires the user of the wireless communication device to provide the first code and the first authentication code.

In one example, the point of sale terminal receives the superimposed photo image from the wireless communication device. In this case, the operator operating the point of sale terminal compares the received superimposed photo image by looking at the user. The operator approves the transaction by inputting an authorization code. In one example, the authorization code may be a watermark placed on the superimposed photo being displayed on the point of sale terminal. In another example, the authentication code may also be a secret code given to the operator operating the point of sale terminal by the trusted party to manually approve or reject transactions. In one example, this comparison of superimposed photo image is skipped when the amount of transaction is low.

In another example, the transaction between the wireless communication device and the point of sale terminal also depends upon the number of transactions that have been carried out over a period of time. For example, if the point of sale terminal or trusted party detects multiple moderately priced transactions or multiple highly priced transactions within a short time, the point of sale terminal or the trusted party requires the completion of steps 715 to 795 in the same order as described for FIG. 7. In this case, the point sale terminal requires the user of the wireless communication device to provide the first code and the first authentication code.

Additionally, if the point of sale terminal and/or trusted party detects some suspicious activity, e.g. transactions made in multiple states in a short time, steps 715 to 795 are repeated in the same order as described for FIG. 7. In this case, the point sale terminal requires the user of the wireless communication device to provide the first code and the first authentication code.

In another example, after the transaction is complete, e.g. step 795, additional verification of the user may be performed by comparing a signature of the user of the wireless communication device. For example, the user has to sign a receipt after the transaction. In this case, the operator operating the point of sale terminal may compare the signature on the receipt against a signature graphic that is optionally stored as a personalized data in the point of sale terminal.

Alternatively, the signature may also be a part of the superimposed photo image as a second watermark. In this case, the operator may look at the signature superimposed on the photo image being displayed on the wireless communication device. The operator may then compare the signature on the receipt with the signature on the superimposed photo image. The operator may cancel or approve the transaction based upon the comparison.

In one embodiment of the present invention, the wireless communication device also contains multiple profiles for multiple users. In this case, for a specific user to perform the transaction during the proximity payment transaction process, an appropriate profile dedicated to the specific user is activated. In one example, after the specific user initiates the proximity payment application, e.g. step 710, the application provides the specific user with a list of profiles to choose from. The specific user may then select the appropriate profile and perform the transaction.

Similarly during proximity payment provisioning, after the specific user initiates the proximity payment application, e.g. step 520, the wireless communication device provides the specific user the list of profiles to choose from. The user then has to select the appropriate profile and transmit the photo image to the trusted party.

In another example, a single user may hold multiple profiles which link to multiple accounts. In this case, the single user may activate any desired profile and perform the transaction. The multiple accounts may be held in one financial institution or different financial institutions.

In one example, the multiple users may use a single account. In this case, multiple users may hold multiple profiles which link to the single account. The multiple profiles may include different provisioned photo images for multiple users. In this example, the different provisioned photo images may have different or same watermarks which may result in different or same authentication codes.

In this document, relational terms such as first and second, top and bottom, and the like may be used solely to distinguish one entity or action from another entity or action without necessarily requiring or implying any actual such relationship or order between such entities or actions. The above description and the diagrams do not illustrate do not necessarily require the order illustrated.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for proximity payment transaction between a wireless purchasing device and a point of sale terminal in conjunction with a trusted party, comprising:
initiating, by the wireless purchasing device, a proximity payment application for a transaction between the wireless purchasing device and the point of sale terminal;
calculating, by the wireless purchasing device, a first authentication code of a superimposed photo image of a user of the wireless purchasing device;
transmitting, by the wireless purchasing device, the first authentication code to the point of sale terminal via a first communication network;
inputting, at the point of sale terminal, a first code placed as a watermark on the superimposed photo image of the user, wherein the superimposed photo image is displayed on the wireless purchasing device;
transmitting, by the point of sale terminal, the first code and the first authentication code to the trusted party via a second communication network; and
receiving, by the point of sale terminal, an approval message from the trusted party for approving the transaction between the wireless purchasing device and the point of sale terminal via the second communication network.

2. The method of claim 1, wherein the superimposed photo image is stored in a first memory of the wireless purchasing device.

3. The method of claim 1, wherein the first authentication code is a cryptographic hash digest code, a hash message authentication code, an encrypted value, or digital signatures.

4. The method of claim 1, wherein the first communication network is a short-range wireless communication network.

5. The method of claim 4, wherein the short-range wireless communication network adheres to a Radio Frequency Identification (RFID), a Near Field Communication (NFC), 802.11, infrared, Bluetooth and the like.

6. The method of claim 1, wherein the first code comprises an approval code, a user identifier of the user, a device identifier of a hardware component of the wireless purchasing device, or a serial number of the wireless purchasing device.

7. The method of claim 1, wherein the second communication network is a long-range communication network.

8. The method of claim 7, wherein the long-range communication network adheres to Ethernet, GSM, CDMA, AMPS, TDMA, iDEN, GPRS, EDGE, UMTS, WCDMA, or CDMA2000.

9. The method of claim 1, wherein transmitting, by the point of sale terminal, further comprises:
receiving, by the trusted party, the first code and the first authentication code;
verifying, by the trusted party, whether the first code is same as a second code and whether the first authentication code is same as a second authentication code, wherein the second code and the second authentication code are stored in a second memory of the trusted party;
approving, by the trusted party, the transaction between the wireless purchasing device and the point of sale terminal if the first code is same as the second code and the first authentication code is same as the second authentication code; and
transmitting, by the trusted party, an approval message to the point of sale terminal for approving the transaction between the wireless purchasing device and the point of sale terminal.

10. The method of claim 9, further comprising:
rejecting, by the trusted party, the transaction between the wireless purchasing device and the point of sale terminal if the first code is not same as the second code and the first authentication code is not same as the second authentication code; and
transmitting, by the trusted party, a rejection message to the point of sale terminal for rejecting the transaction between the wireless purchasing device and the point of sale terminal.

11. The method of claim 9, wherein the second authentication code is calculated over the superimposed photo image.

12. The method of claim 11, wherein the calculated second authentication code is stored in the second memory during proximity payment provisioning.

13. A system for performing proximity payment transaction process, comprising:
a wireless purchasing device configured to calculate a first authentication code over a superimposed photo image of a user of the wireless purchasing device, wherein the superimposed photo image is stored in a first memory of the wireless purchasing device;
a point of sale terminal, connectable to the wireless purchasing device via a first communication network, configured to input a first code placed as a watermark on the superimposed photo image, wherein the superimposed photo image is displayed on the wireless purchasing device; and
a trusted party, connectable to the point of sale terminal via a second communication network, configured to approve a transaction between the wireless purchasing device and the point of sale terminal.

14. The system of claim 13, wherein the wireless purchasing device is further configured to include a user interface for initiating the transaction with the point of sale terminal.

15. The system of claim 13, wherein the first authentication code is a cryptographic hash digest value, a hash message authentication code, an encrypted value or digital signatures.

16. The system of claim 13, wherein the wireless purchasing device is further configured to transmit the first authentication code to the point of sale terminal via the first communication network.

17. The system of claim 13, wherein the first communication network is a short-range wireless communication network.

18. The system of claim 13, wherein the second communication network is a long-range communication network.

19. The system of claim 13, wherein the point of sale terminal is further configured to transmit the first code and the first authentication code to the trusted party via the second communication network.

20. The system of claim 13, wherein the trusted party is further configured to verify whether the first code is same as a second code and whether the first authentication code is same as a second authentication code, wherein the second code and the second authentication code are stored in a second memory of the trusted party.

21. The system of claim 13, wherein the trusted party is further configured to reject a transaction between the wireless purchasing device and the point of sale terminal.

22. A method for proximity payment transaction between a wireless purchasing device and a point of sale terminal in conjunction with a trusted party, comprising:
initiating, by the wireless purchasing device, a proximity payment application for a transaction between the wireless purchasing device and the point of sale terminal;
inputting, at the point of sale terminal, a first code placed as a watermark on a superimposed photo image, wherein the superimposed photo image is displayed on the wireless communication device;
transmitting, by the point of sale terminal, the first code to the trusted party via a second communication network; and
receiving, by the point of sale terminal, an approval message from the trusted party for approving the transaction between the wireless purchasing device and the point of sale terminal.
